(19) United States
(12) Patent Application Publication
(10) Pub. No.: US 2006/0207547 A1
(43) Pub. Date: Sep. 21, 2006

(54) Internal Combustion engine

(75) Inventor: Haruhiko Saito, Toyota-shi (JP)

Correspondence Address: OLIFF & BERRIDGE, PLC, P.O. BOX 19928, ALEXANDRIA, VA, 22320, US

(73) Assignee: Toyota Jidosha Kabushiki Kaisha, Toyota-shi (JP)

(21) Appl. No.: 11/331,066

(22) Filed: Jan. 13, 2006

(30) Foreign Application Priority Data
Mar. 18, 2005 (JP) 2005-078294

(51) Int. Cl. F02B 3/02; F02F 3/26; F02B 1/02

(52) U.S. Cl. 123/260; 123/276; 123/298; 123/431

(57) ABSTRACT

An in-cylinder injector injects a spray such that the spray spreads in an inverted V-shape with a spark plug lying between two prongs when viewed from above and in a fan shape when viewed from a side. On a top surface of a piston, a cavity having a bottom surface and an outermost side surface is provided, the bottom surface directing the spray spread in a fan shape when viewed from above toward the spark plug when the spray impinges thereon, and the outermost side surface directing the spray spread in the inverted V-shape when viewed two-dimensionally toward the spark plug when the spray impinges thereon. When viewed from above, cavity is arranged in such a position as not overlapping with a position of a piston pin boss portion provided in a lower portion of the piston.

This nonprovisional application is based on Japanese Patent Application No. 2005-078294 filed with the Japan Patent Office on Mar. 18, 2005, the entire contents of which are hereby incorporated by reference.

### BACKGROUND OF THE INVENTION

1. Field of the Invention

The present invention relates to an internal combustion engine for a vehicle, and more particularly to an internal combustion engine that includes at least a first fuel injection mechanism (in-cylinder injector) for injecting a fuel into a cylinder and further includes a second fuel injection mechanism (intake manifold injector) for injecting a fuel into an intake manifold or an intake port.

2. Description of the Background Art

An internal combustion engine provided with an intake manifold injector for injecting a fuel into an intake manifold and an in-cylinder injector for injecting a fuel into a combustion chamber, in which fuel injection from the intake manifold injector is stopped when load of the engine is lower than preset load and fuel injection from the intake manifold injector is allowed when load of the engine is higher than the preset load, is known.

An in-cylinder injection type engine aiming at improvement in combustion efficiency and purification of exhaust gas by making smaller particles of fuel injected into the cylinder represents one example of techniques related to such an in-cylinder injector in an internal combustion engine. For example, Japanese Patent Laying-Open No. 2003-254199 discloses an in-cylinder fuel injection type internal combustion engine that achieves ensured improvement in fuel efficiency by permitting setting of a high compression ratio even when an average air-fuel ratio of the whole air-fuel mixture in a cylinder bore is high and when the air-fuel mixture is lean on the average such as in a low load state of the internal combustion engine. In the in-cylinder fuel injection type internal combustion engine, an intake manifold is formed on one side of a cylinder head, whereas an exhaust manifold is formed on the other side thereof when the cylinder in which an axial center of the cylinder bore is aligned with a vertical line is viewed from a side. The in-cylinder fuel injection type internal combustion engine includes a fuel injection valve capable of injecting the fuel in an obliquely downward direction from an end side on one side of the cylinder head into the cylinder bore and a spark plug of which discharge portion is exposed within the cylinder bore substantially on the axial center of the cylinder bore. In the in-cylinder fuel injection type internal combustion engine, when the cylinder is viewed two-dimensionally, the fuel injected from the fuel injection valve is in an inverted V-shape with the discharge portion lying between two prongs, and the fuel is injected from the fuel injection valve in an intake stroke.

According to the in-cylinder fuel injection type internal combustion engine, the fuel injected from the fuel injection valve is in an inverted V-shape with the discharge portion lying between the two prongs. In addition, in the intake stroke of the internal combustion engine, the piston is lowered from the top dead center. This direction of lowering is the same as the direction of injection of the fuel from the fuel injection valve. Therefore, the fuel injected from the fuel injection valve travels along each outer side of the discharge portion. Here, furious collision of the fuel with an upper surface of the piston is prevented, and the fuel smoothly travels in a direction of injection. When forward ends of respective injected fuel prongs on the left and right reach an inner circumferential surface of the cylinder bore and the upper surface of the piston, the fuels are guided by these surfaces so that some part of the fuels comes closer to each other in a circumferential direction of the cylinder bore, while other part thereof moves away from each other in the circumferential direction of the cylinder bore. Then, in the intake stroke and the following compression stroke, most of the fuel injected into the cylinder bore is concentrated in an area in the vicinity of the inner circumferential surface of the cylinder bore substantially uniformly in the circumferential direction. Namely, when the cylinder is viewed two-dimensionally, a stratified, ring-shaped rich air-fuel mixture substantially around the axial center of the cylinder bore and a stratified, lean air-fuel mixture surrounded by the stratified rich air-fuel mixture and located in the vicinity of the discharge portion are formed in the cylinder bore.

Alternatively, the top surface of the piston may not be flat but provided with a shallow recess called a cavity. Japanese Patent Laying-Open No. 6-257506 discloses a swirl generation apparatus in a piston of an internal combustion engine, aiming to allow adoption of a tangential port as an intake port and to simultaneously achieve a high flow coefficient and strong swirl by generating strong swirl in a combustion chamber. In the swirl generation apparatus in the piston of the internal combustion engine, the piston of the internal combustion engine is divided into an upper part and a lower part that are engaged with each other in a manner slidable in a circumferential direction by means of a slide surface in parallel to a plane at a right angle with respect to an axis of the piston. Gear teeth are provided in a lower surface of the upper part of the piston in the circumferential direction and gear teeth that are engaged with the former gear teeth are formed on a top outer circumferential surface of a small end portion of a connecting rod, so that movement of the gear teeth in the small end portion of the connecting rod is transmitted, with the up-down movement of the piston, to the upper part of the piston via the gear teeth, which in turn causes reciprocating motion of the upper part of the piston in the circumferential direction. The upper part of the piston includes a pattern of convex and concave portions, a concave portion, or a convex portion.

According to the swirl generation apparatus in the piston of the internal combustion engine, movement of the gear of the connecting rod at the small end portion of the connecting rod is transmitted to the upper part of the piston via the piston gear, so that the upper part of the piston carries out reciprocating motion in the circumferential direction. As a result of the convex and concave pattern provided in the top portion of the upper part of the piston, strong swirl can be generated in an air-fuel mixture or air in the combustion chamber, with the reciprocating motion of the upper part of the piston.

Japanese Patent Laying-Open No. 2003-254199 discloses an internal combustion engine in which a fuel is injected into a cylinder by using a fuel injection valve characterized by a spray shape and a spray direction. Here, a valve recess is provided in a top surface (upper surface) of a piston, and furious collision of fuel spray with the top surface of the cylinder is prevented. In addition, when the cylinder is viewed two-dimensionally, a stratified, ring-shaped rich air-fuel mixture substantially around an axial center of a cylinder bore and a stratified, lean air-fuel mixture surrounded by the stratified, rich air-fuel mixture and located in the vicinity of a discharge portion are formed.

Meanwhile, it is sometimes desired that the fuel injection valve characterized by the spray shape and the spray direction as disclosed in Japanese Patent Laying-Open No. 2003-254199 is used to concentrate the fuel within the cylinder in an area around the spark plug in order to achieve a richer air-fuel mixture around the same, for the purpose of preventing misfire or improving fuel efficiency by improving combustion.

In this case, such a cavity as guiding the fuel spray toward the top surface of the piston is provided. The cavity disclosed in Japanese Patent Laying-Open No. 6-257506, however, is mainly directed to forming a swirl. Therefore, even if the fuel injection valve disclosed in Japanese Patent Laying-Open No. 2003-254199 is combined with the piston having the cavity disclosed in Japanese Patent Laying-Open No. 6-257506, a rich air-fuel mixture cannot be formed around the spark plug.

In addition, the piston is connected to the connecting rod (the small end of the connecting rod) by means of a piston pin. The piston includes a piston pin boss portion for accommodating the piston pin. Here, strong gas force and inertia force of the piston are directly applied to the piston pin or to the piston pin boss portion, and large stress is generated in the piston pin boss portion. Therefore, possibility of breakage of the piston due to stress concentration should be avoided by devising a position or a shape of the piston pin boss portion.

### SUMMARY OF THE INVENTION

An object of the present invention is to provide an internal combustion engine including a fuel injection mechanism for injecting a fuel into a cylinder, capable of locally forming a rich air-fuel mixture and mitigating stress in a piston.

An internal combustion engine according to the present invention includes a fuel injection mechanism for injecting a fuel into a cylinder. The internal combustion engine includes: an intake manifold formed on one side of a cylinder head when a cylinder, in which an axial center of a cylinder bore is aligned with a vertical line, is viewed from a side; an exhaust manifold formed on a side opposite to the intake manifold; and a piston making up-down movement through the cylinder bore. The fuel injection mechanism is capable of injecting a fuel in an obliquely downward direction from an end side on one side of the cylinder head into the cylinder bore. In a top surface of the piston, a cavity is provided such that a spray formed by the fuel injected from the fuel injection mechanism impinges on the top surface of the piston in its outermost portion. When the cylinder is viewed two-dimensionally, a position of the cavity is displaced from a position of a piston pin boss.

According to the present invention, for example, the fuel injected from the in-cylinder injector representing one example of the fuel injection mechanism spreads in an inverted V-shape with the spark plug lying between two prongs when the cylinder is viewed two-dimensionally and in a fan shape when the cylinder is viewed from the side. In this manner, for example, even if a swirl control valve for generating a vortex flow is eliminated in order to achieve a higher flow rate, homogeneity of a mixture of the fuel injected from the in-cylinder injector and intake air can be improved to such an extent as not causing combustion fluctuation. In addition, a cavity is provided in the top surface of the piston such that the spray spread in an inverted V-shape injected from the in-cylinder injector impinges on the top surface of the piston in the outermost portion. The spray that has impinged on the cavity is directed from the outermost portion toward the inner side (that is, toward the discharge portion located substantially on the axial center of the cylinder bore). Consequently, the spray formed by the fuel injected from the in-cylinder injector can be concentrated in the vicinity of the discharge portion of the spark plug. Accordingly, a rich state is achieved in the vicinity of the spark plug, and prevention of misfire or improvement in fuel efficiency by improving combustion can be achieved. Moreover, the cavity serving as a recess is formed in the top surface of the piston, and the position of the cavity is displaced from the position of the piston pin boss provided in the lower portion of the piston (encompassing complete displacement or partial displacement). Therefore, sufficient strength can be realized as compared with an example in which there is no displacement, and possibility of breakage of the piston due to stress concentration can be avoided. It is noted that the position of the cavity may partially overlap with the position of the piston pin boss, namely displacement may be partial, provided that possibility of breakage of the piston due to stress concentration can be avoided. As a result, an internal combustion engine including a fuel injection mechanism for injecting a fuel into a cylinder, capable of forming a rich air-fuel mixture around the spark plug and mitigating stress in the piston can be provided.

Preferably, in the internal combustion engine according to the present invention, when the cylinder is viewed two-dimensionally, there is no overlap between the position of the cavity and the position of the piston pin boss.

According to the present invention, as the position of the cavity serving as the recess in the top surface of the piston does not overlap with (is completely displaced from) the position of the piston pin boss provided in the lower portion of the piston, sufficient strength can be achieved and possibility of breakage of the piston due to stress concentration can be avoided

Preferably, the internal combustion engine according to the present invention further includes a spark plug of which discharge portion is exposed within the cylinder bore substantially on the axial center of the cylinder bore.

According to the present invention, in the internal combustion engine having a spark plug substantially on the axial center of the cylinder bore and including a fuel injection mechanism for injecting a fuel into a cylinder, a rich air-fuel mixture is formed around the spark plug and stress in the piston can be mitigated.

Preferably, the internal combustion engine according to the present invention further includes a spark plug of which discharge portion is exposed within the cylinder bore.

According to the present invention, in the internal combustion engine having a spark plug and including a fuel injection mechanism for injecting a fuel into a cylinder, a rich air-fuel mixture is formed around the spark plug and stress in the piston can be mitigated.

Preferably, in the internal combustion. engine according to the present invention, when the cylinder is viewed two-dimensionally, the fuel injected from the fuel injection mechanism is in an inverted V-shape with the discharge portion lying between two prongs.

According to the present invention, in the internal combustion engine in which the spray formed by the fuel injected from the fuel injection mechanism is in an inverted V-shape with the discharge portion lying between the two prongs when the cylinder is viewed two-dimensionally, a rich air-fuel mixture is formed around the spark plug and stress in the piston can be mitigated.

Preferably, in the internal combustion engine according to the present invention, when the cylinder is viewed two-dimensionally, the fuel injected from the fuel injection mechanism is in an inverted V-shape with the discharge portion lying between two prongs, and when the cylinder is viewed from a side, the fuel injected from the fuel injection mechanism is in a fan shape.

According to the present invention, in the internal combustion engine in which the spray formed by the fuel injected from the fuel injection mechanism is in an inverted V-shape with the discharge portion lying between the two prongs when the cylinder is viewed two-dimensionally and the fuel injected from the fuel injection mechanism is in a fan shape when the cylinder is viewed from the side, a rich air-fuel mixture is formed around the spark plug and stress in the piston can be mitigated.

Preferably, in the internal combustion engine according to the present invention, the cavity is shaped such that the spray that impinges on the outermost portion is directed toward the discharge portion when the cylinder is viewed two-dimensionally.

According to the present invention, when the cylinder is viewed two-dimensionally, the cavity is shaped such that the spray that impinges on the outermost portion is directed toward the discharge portion (toward the center). Therefore, the spray formed by the fuel injected from the in-cylinder injector (in an inverted V-shape when viewed two-dimensionally) is directed toward the discharge portion, so as to form a rich air-fuel mixture in the vicinity of the discharge portion.

Preferably, in the internal combustion engine according to the present invention, the cavity is shaped such that the spray that impinges on a bottom portion of the cavity is directed toward the discharge portion when the cylinder is viewed from a side.

According to the present invention, when the cylinder is viewed from the side, the cavity is shaped such that the spray that impinges on the bottom portion is directed toward the discharge portion (upward). Therefore, the spray formed by the fuel injected from the in-cylinder injector (in a fan shape when viewed from the side) is directed toward the discharge portion, so as to form a rich air-fuel mixture in the vicinity of the discharge portion.

Preferably, the internal combustion engine according to the present invention further includes a fuel injection mechanism injecting a fuel into an intake manifold.

According to the present invention, in addition to the in-cylinder injector, the fuel is injected from the intake manifold injector into the intake manifold so as to improve homogeneity of the air-fuel mixture during homogenous combustion.

Preferably, in the internal combustion engine according to the present invention, the fuel injection mechanism for injecting the fuel into the cylinder is an in-cylinder injector, and the fuel injection mechanism for injecting the fuel into the intake manifold is an intake manifold injector.

According to the present invention, in the internal combustion engine in which the in-cylinder injector serving as the fuel injection mechanism for injecting the fuel into the cylinder and the intake manifold injector for injecting the fuel into the intake manifold are separately provided to inject the fuel, a rich air-fuel mixture is formed around the spark plug and stress in the piston can be mitigated.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic configuration diagram of an engine system controlled by a control device according to an embodiment of the present invention.

FIG. 2 is a partially enlarged view of FIG. 1.

FIG. 3 is a cross-sectional view of an in-cylinder injector.

FIG. 4 is a cross-sectional view of an injection hole of the in-cylinder injector.

FIG. 5 illustrates a shape of spray from the in-cylinder injector.

FIG. 6 is a side view of a cavity in a top surface of a piston.

FIG. 7 is a plan view of the cavity in the top surface of the piston.

FIGS. 8 and 9 illustrate a first example of DI ratio maps in a warm state and a cold state respectively, of an engine to which the control device according to the embodiment of the present invention is suitably adapted.

FIGS. 10 and 11 illustrate a second example of DI ratio maps in a warm state and a cold state respectively, of an engine to which the control device according to the embodiment of the present invention is suitably adapted.

### DESCRIPTION OF THE PREFERRED EMBODIMENTS

An embodiment of the present invention will be described hereinafter with reference to the drawings. The same elements have the same reference characters allotted. Their label and function are also identical. Therefore, detailed description thereof will not be repeated.

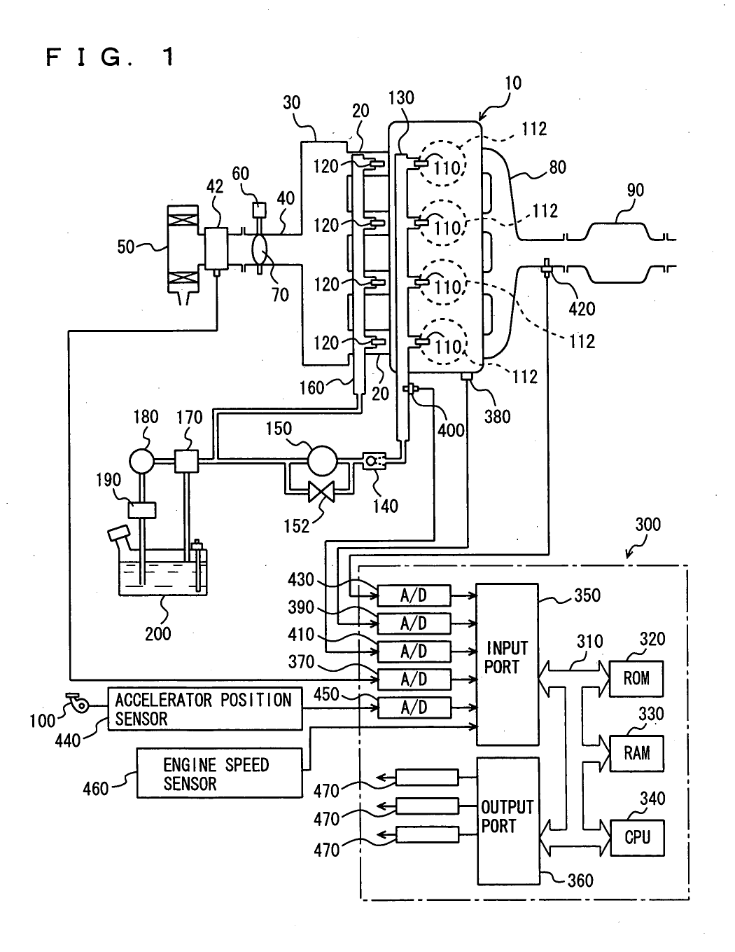

FIG. 1 schematically shows a configuration of an engine system controlled by an engine ECU (Electronic Control Unit) that is a control device of an internal combustion engine according to an embodiment of the present invention. Although an in-line 4-cylinder gasoline engine is shown in FIG. 1, application of the present invention is not restricted to the engine shown, and the engine may be a V-type 6-cylinder engine, a V-type 8-cylinder engine and an in-line 6-cylinder engine. In addition, though an engine having an in-cylinder injector and an intake manifold injector will be described hereinafter, the present invention is applicable to any engine having at least an in-cylinder injector.

As shown in FIG. 1, an engine 10 includes four cylinders 112, which are connected via corresponding intake manifolds 20 to a common surge tank 30. Surge tank 30 is connected via an intake duct 40 to an air cleaner 50. In intake duct 40, an airflow meter 42 and a throttle valve 70, which is driven by an electric motor 60, are disposed. Throttle valve 70 has its opening position controlled based on an output signal of an engine ECU (Electronic Control Unit) 300, independently of an accelerator pedal 100. Cylinders 112 are connected to a common exhaust manifold 80, which is in turn connected to a three-way catalytic converter 90.

For each cylinder 112, an in-cylinder injector 110 for injecting fuel into the cylinder and an intake manifold injector 120 for injecting fuel into an intake port and/or. an intake manifold are provided. These injectors 110, 120 are controlled based on output signals of engine ECU 300. In-cylinder injectors 110 are connected to a common fuel delivery pipe 130. Fuel delivery pipe 130 is connected to a high-pressure fuel pump 150 of an engine driven type via a check valve 140 that allows flow toward fuel delivery pipe 130. In the present embodiment, description will be made as to the internal combustion engine having two injectors provided separately, although the present invention is not limited thereto. For example, the internal combustion engine may have a single injector capable of performing both in-cylinder injection and intake manifold injection.

As shown in FIG. 1, the discharge side of high-pressure fuel pump 150 is connected to the intake side of high-pressure fuel pump 150 via an electromagnetic spill valve 152. It is configured such that the quantity of the fuel supplied from high-pressure fuel pump 150 to fuel delivery pipe 130 increases as the degree of opening of electromagnetic spill valve 152 is smaller, and that fuel supply from high-pressure fuel pump 150 to fuel delivery pipe 130 is stopped when electromagnetic spill valve 152 is fully opened. Electromagnetic spill valve 152 is controlled based on an output signal of engine ECU 300.

Meanwhile, intake manifold injectors 120 are connected to a common fuel delivery pipe 160 on the low-pressure side. Fuel delivery pipe 160 and high-pressure fuel pump 150 are connected to a low-pressure fuel pump 180 of an electric motor driven type via a common fuel pressure regulator 170. Further, low-pressure fuel pump 180 is connected to a fuel tank 200 via a fuel filter 190. Fuel pressure regulator 170 is configured to return a part of the fuel discharged from low-pressure fuel pump 180 to fuel tank 200 when the pressure of the fuel discharged from low-pressure fuel pump 180 becomes higher than a preset fuel pressure. This prevents the pressure of the fuel supplied to intake manifold injectors 120 as well as the pressure of the fuel supplied to high-pressure fuel pump 150 from becoming higher than the preset fuel pressure.

Engine ECU 300 is configured with a digital computer, which includes a ROM (Read Only Memory) 320, a RAM (Random Access Memory) 330, a CPU (Central Processing Unit) 340, an input port 350, and an output port 360, which are connected to each other via a bidirectional bus 310.

Airflow meter 42 generates an output voltage that is proportional to an intake air quantity, and the output voltage of airflow meter 42 is input via an A/D converter 370 to input port 350. A coolant temperature sensor 380 is attached to engine 10, which generates an output voltage proportional to an engine coolant temperature. The output voltage of coolant temperature sensor 380 is input via an A/D converter 390 to input port 350.

A fuel pressure sensor 400 is attached to fuel delivery pipe 130, which generates an output voltage proportional to a fuel pressure in fuel delivery pipe 130. The output voltage of fuel pressure sensor 400 is input via an A/D converter 410 to input port 350. An air-fuel ratio sensor 420 is attached to exhaust manifold 80 located upstream of three-way catalytic converter 90. Air-fuel ratio sensor 420 generates an output voltage proportional to an oxygen concentration in the exhaust gas, and the output voltage of air-fuel ratio sensor 420 is input via an A/D converter 430 to input port 350.

Air-fuel ratio sensor 420 in the engine system of the present embodiment is a full-range air-fuel ratio sensor (linear air-fuel ratio sensor) that generates an output voltage proportional to an air-fuel ratio of the air-fuel mixture burned in engine 10. As air-fuel ratio sensor 420, an O₂ sensor may be used which detects, in an on/off manner, whether the air-fuel ratio of the mixture burned in engine 10 is rich or lean with respect to a theoretical air-fuel ratio.

Accelerator pedal 100 is connected to an accelerator position sensor 440 that generates an output voltage proportional to a degree of press-down of accelerator pedal 100. The output voltage of accelerator position sensor 440 is input via an A/D converter 450 to input port 350. An engine speed sensor 460 generating an output pulse representing the engine speed is connected to input port 350. ROM 320 of engine ECU 300 prestores, in the form of a map, values of fuel injection quantity that are set corresponding to operation states based on the engine load factor and the engine speed obtained by the above-described accelerator position sensor 440 and engine speed sensor 460, respectively, and the correction values based on the engine coolant temperature.

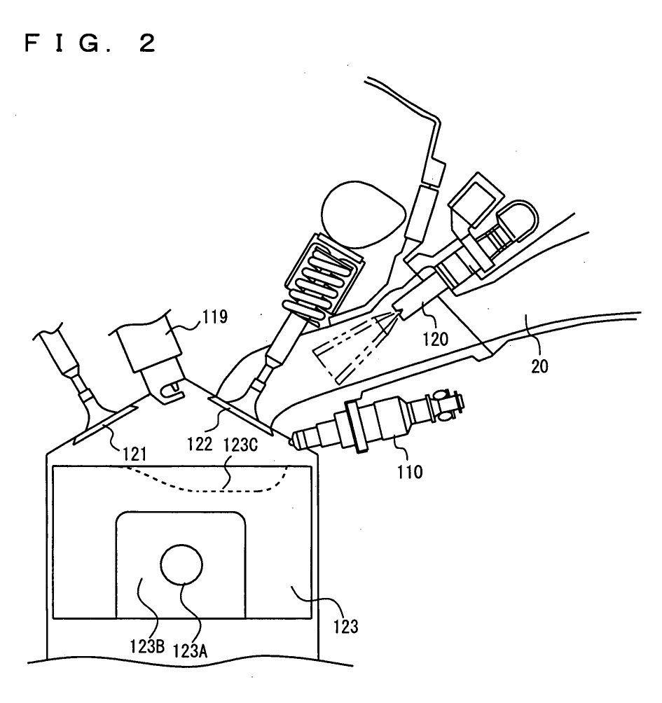

FIG. 2 is a partially enlarged view of FIG. 1. FIG. 2 illustrates positional relation of in-cylinder injector 110 and intake manifold injector 120 in each cylinder 112 shown in FIG. 1 as well as positional relation of intake manifold 20, an intake valve 122, an exhaust valve 121, a spark plug 119, and a piston 123.

Intake valve 122 is provided on the combustion chamber side of intake manifold 20, and intake manifold injector 120 is arranged upstream of intake valve 122. Intake manifold injector 120 injects the fuel toward an inner wall of intake manifold 20 that serves as an intake air passage.

An example of a direction of fuel injection from intake manifold injector 120 may be as follows.

PM (Particulate Matter) within the combustion chamber flows back to intake manifold 20 due to overlap between intake valve 122 and exhaust valve 121, and the fuel injected from intake manifold injector 120 is sprayed toward the inner wall of intake manifold 20. Then, particulate fuel serves as an adhesive and may remain as deposits on the inner wall of intake manifold 20 on a side close to intake valve 122. The direction of fuel injection from intake manifold injector 120 is set to a direction toward the deposits, so that the deposits can be washed away by the fuel injected from the intake manifold injector 120.

In intake manifold 20, a component for forming a vortex flow in the combustion chamber such as a swirl control valve is not provided. If such a swirl control valve is provided, the flow coefficient is lowered and air in an amount necessary and sufficient at the time of WOT cannot flow into the combustion chamber. In the internal combustion engine according to the present embodiment, however, a higher flow coefficient is set so as to implement a high flow rate port. It is noted that a tangential type intake port may be provided, so long as a high flow rate can be achieved. The tangential type port does not have such a spiraling shape around intake valve 122 as swinging to the left and right but extends straight and has an arcing end portion swinging up and down along a large arc. Therefore, resistance to flow within the intake port is small, and the flow coefficient of the intake port is much greater than that of the swirl port. Namely, volumetric efficiency is higher, and a large amount of air can be suctioned into the combustion chamber. Preferably, a flow coefficient Cf of the intake port is set to a value of 0.5 to 0.7 or higher.

As shown in FIG. 2, a cavity 123C which is a recess having a gently curved contour is provided in the. top portion of piston 123, in a position opposing in-cylinder injector 110. The fuel is injected from in-cylinder injector 110 toward cavity 123C. As the top portion of piston 123 opposing in-cylinder injector 110 does not have a corner portion, the spray formed by the fuel injected from in-cylinder injector 110 is not divided by the comer portion. If the sprayed fuel is divided, a local rich state that adversely affects combustion (local rich herein refers to formation of a rich air-fuel mixture in an area other than the area in the vicinity of spark plug 119) may be caused. Such a state, however, can be avoided. It is noted that detailed description of the shape of the fuel sprayed from in-cylinder injector 110 will be given later. In addition, detailed description as to how the spray formed by the fuel injected from in-cylinder injector 110 is transformed as a result of cavity 123C will also be given later. Moreover, a ratio of fuel injection between in-cylinder injector 110 and intake manifold injector 120 arranged as shown in FIG. 2 will be described in detail later.

As shown in FIG. 2, with regard to piston 123, piston 123 is connected to the connecting rod (not shown) by means of a piston pin 123A. Piston 123 includes a piston pin boss portion 123B for accommodating piston pin 123A. Strong gas force and inertia force of piston 123 are directly applied to piston pin 123A or to piston pin boss portion 123B, and large stress is generated in piston pin boss portion 123B. Therefore, a position or a shape of piston pin boss portion 123B is devised in order to avoid possibility of breakage of piston 123 due to stress concentration. In particular, in engine 10 according to the present embodiment, the position of piston pin boss portion 123B is displaced from the position of cavity 123C. Unless the position of piston pin boss portion 123B is displaced from the position of cavity 123C as above, concentration of stress is structurally caused. Accordingly, in the piston 123 of engine 10 according to the present embodiment, overlapping of the position of piston pin boss portion 123B and the position of cavity 123C is avoided, so that possibility of breakage of piston 123 due to stress concentration is prevented. It is noted that the position of piston pin boss portion 123B may partially overlap with the position of cavity 123, provided that possibility of breakage of piston 123 due to stress concentration can be avoided.

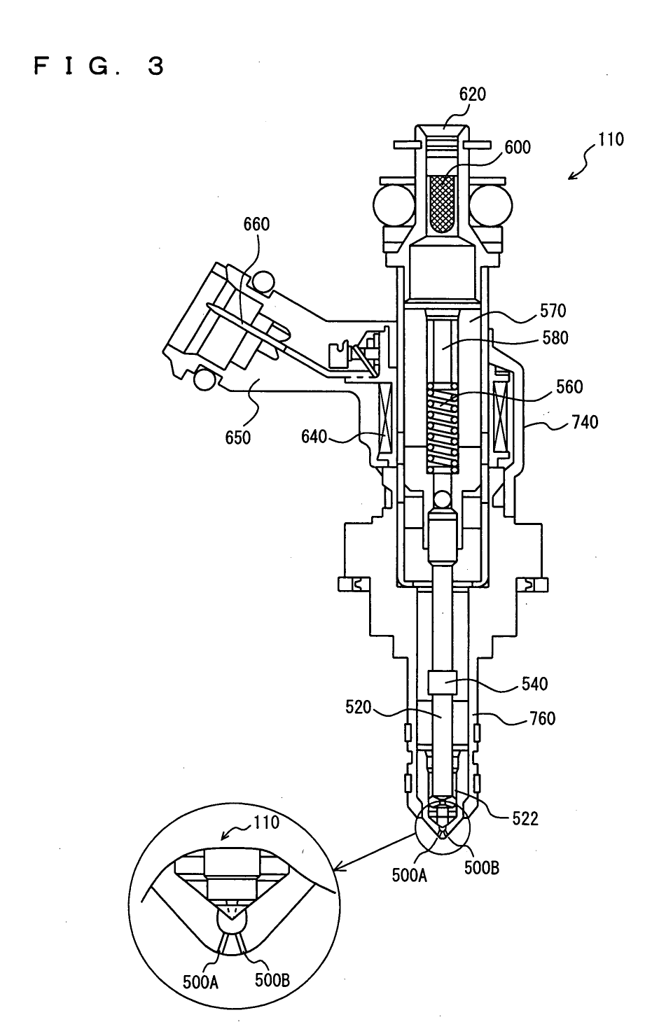

Referring to FIG. 3, in-cylinder injector 110 will be described. FIG. 3 is a longitudinal cross-sectional view of in-cylinder injector 110.

As shown in FIG. 3, in-cylinder injector 110 has a nozzle body 760 in a lower end of its main body 740, and nozzle body 760 is fixed by a nozzle holder with a spacer being interposed. Nozzle body 760 has an injection hole 500A and an injection hole 500B formed in its lower end, and a needle 520 is arranged in nozzle body 760 in a manner movable in the up-down direction. An upper end of needle 520 abuts on a core 540 which is slidable within main body 740. A spring 560 energizes needle 520 downward via core 540. Needle 520 is seated on an inner circumferential seat surface 522 of nozzle body 760, and consequently injection hole 500A and injection hole 500B are closed in a normal state.

A sleeve 570 is inserted in and fixed to the upper end of main body 740. A fuel passage 580 is formed in sleeve 570. Fuel passage 580 communicates, in its lower end, to the inside of nozzle body 760 through the passage in main body 740, so that the fuel is injected from injection hole 500A and injection hole 500B when needle 520 is lifted. The upper end of fuel passage 580 is connected to a fuel introduction port 620 through a filter 600, which is in turn connected to fuel delivery pipe 130 in FIG. 1.

An electromagnetic solenoid 640 is arranged so as to surround the lower end portion of sleeve 570 within main body 740. While a current is fed to solenoid 640, core 540 is lifted against spring 560, needle 520 is lifted as a result of a fuel pressure, and injection hole 500A and injection hole 500B are opened, whereby fuel injection is performed. Solenoid 640 is taken out to a wire 660 within an insulating housing 650, so that solenoid 640 can receive an electric signal for valve opening from engine ECU 300. If engine ECU 300 does not output the electric signal for valve opening, fuel injection from in-cylinder injector 110 is not performed.

Fuel injection timing and a fuel injection period of in-cylinder injector 110 are controlled by the electric signal for valve opening received from engine ECU 300. The fuel injection period is controlled so as to regulate an amount of fuel injection from in-cylinder injector 110. In other words, the electric signal may be used to control fuel injection also in order to achieve fuel injection of a small amount (in a region not smaller than a minimum fuel injection amount). It is noted that an EDU (Electronic Driver Unit) may be provided between engine ECU 300 and in-cylinder injector 110 for such control. It is noted that the pressure of fuel supplied to in-cylinder injector 110 structured as above is very high (approximately 13 MPa).

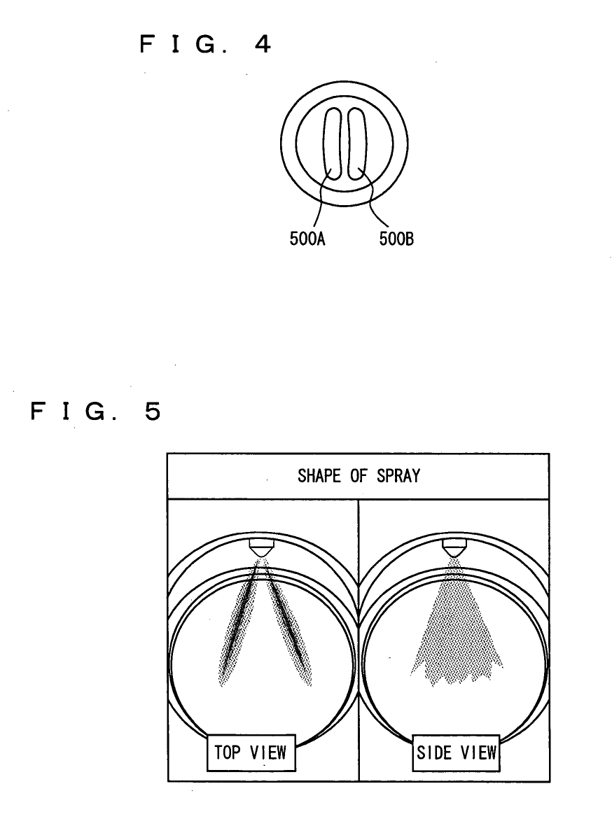

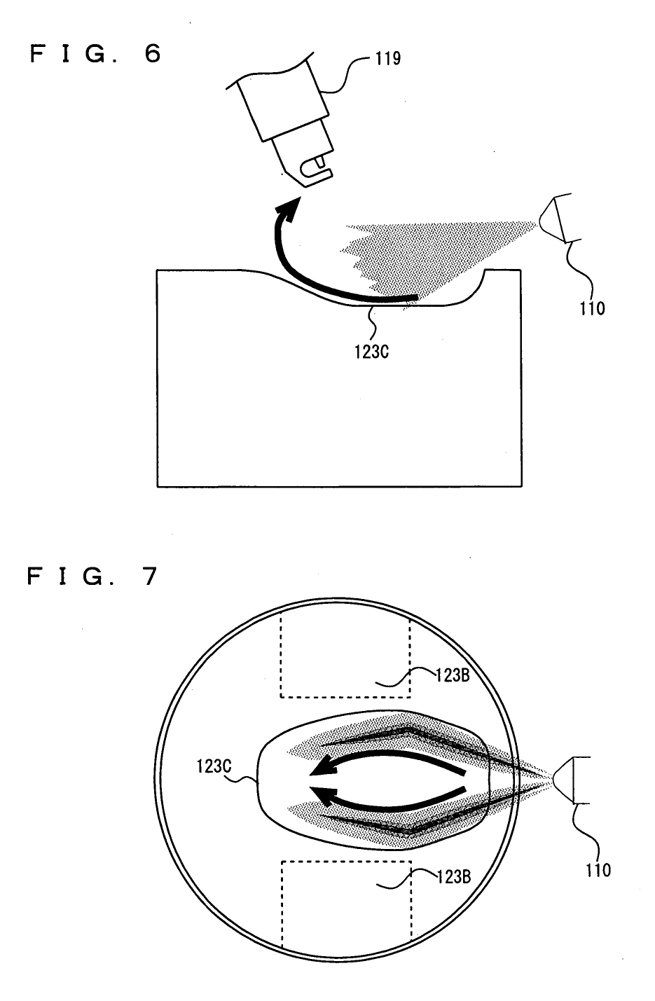

FIG. 4 shows injection hole 500A and injection hole 500B viewed from the inside of in-cylinder injector 110. As shown in FIG. 4, injection holes in an oblong slit shape are formed in parallel to each other (oblong W slits). The fuel injected through injection hole 500A and injection hole 500B spreads in an inverted V-shape when viewed from above, as shown in FIG. 5, with spark plug 119 provided between two prongs. In addition, the fuel injected through injection hole 500A and injection hole 500B spreads in a shape of a fan opened in directions both up and down when viewed from the side, as shown in FIG. 5.

When viewed from above, spark plug 119 is provided between the two prongs. Therefore, restrained atomization resulting from impinging of the spray on spark plug 119 can be avoided. Meanwhile, when viewed from the side, the spray is in a shape of a fan opened in both up and down directions, and cavity 123C formed by a gently curved contour is provided in the top portion of piston 123. When the piston has a flat top surface, the fuel injected from in-cylinder injector 110 adheres to that flat surface and atomization is prevented. Such restrained atomization, however, is avoided by means of cavity 123C. Cavity 123C will be described further in detail later.

It is noted that the shape of the spray may be:

1) in a fan shape containing spark plug 119 when viewed from above (when viewed two-dimensionally) and in a fan shape when viewed from the side;

2) in a fan shape containing spark plug 119 when viewed from above and in a fan shape of only upper half when viewed from the side;

3) in a fan shape containing spark plug 119 when viewed from above and in a fan shape of only lower half when viewed from the side; or

4) in a fan shape containing spark plug 119 when viewed from the side.

Alternatively, the shape of the injection hole for achieving such a spray shape is not limited to the oblong W slits shown in FIG. 4. The injection hole may be implemented by an oblong S (single) slit, a T-shaped slit, or a cross-shaped slit.

In engine 10 according to the present embodiment, homogenous combustion is conducted in such a manner that the fuel is injected into the cylinder from in-cylinder injector 110 in the intake stroke to form a homogenous air-fuel mixture in the cylinder by the time of ignition in the last part of the compression stroke. In order to form sufficiently homogenized, satisfactory homogenous air-fuel mixture, desirably, the injected fuel is distributed extensively in the cylinder. To that end, in engine 10 according to the present embodiment, in-cylinder injector 110 forms a fuel spray in a shape of a fan opened in directions both up and down when viewed from the side and in an inverted V-shape when viewed from above, as described above.

The spray in such a shape attains greater traveling force than a spray in a cone shape. Accordingly, the fuel is made finer as a result of friction with the intake air within the cylinder while the fuel flies, and readily vaporized. With the use of such a fuel spray in a fan shape when viewed from the side, the fuel spray that tends to be readily vaporized can be distributed in the whole cylinder, so that a sufficiently homogenous air-fuel mixture is formed and satisfactory homogenous combustion can be achieved.

Meanwhile, at the time of start of engine 10, three-way catalytic converter 90 provided in the exhaust system should be warmed up at an early stage in order to activate the catalyst and start purifying the exhaust gas. As one approach to do so, desirably, ignition timing is significantly retarded, for example, to an intermediate stage or later of the expansion stroke, so as to considerably raise a temperature of the exhaust gas.

With regard to the homogenous air-fuel mixture, however, if the ignition timing is significantly retarded as above, misfire may take place. Therefore, for example, in engine 10 according to the present embodiment, stratified charge combustion is conducted from the start of engine 10 or from immediately after the start of engine 10 until completion of warm-up of three-way catalytic converter 90. Here, stratified charge combustion is such that the fuel is injected in the latter half of the compression stroke and the fuel is concentrated in the vicinity of spark plug 119 to form a combustible air-fuel mixture. Ignition and burning of such a combustible air-fuel mixture can be ensured even if the ignition timing is significantly retarded.

A time period from fuel injection to ignition is relatively short in stratified charge combustion. Therefore, in order to ensure vaporization of the injected fuel by the time of ignition, preferably, the fuel is injected into cavity 123C formed in the top surface of piston 123 notionly to atomize the fuel during spraying but also to receive heat from cavity 123C. In the present embodiment, cavity 123C is provided for that purpose in the top surface of piston 123. In a general in-cylinder spark ignition type engine, the cavity is formed in a position closer to the injector in the top surface of the piston. When the fuel spray in a fan shape is formed by in-cylinder injector 110 as in the present embodiment, a large amount of fuel is injected outside the cavity in the cylinder.

As the fuel injected outside the cavity is not guided by the cavity to an area in the vicinity of spark plug 119, it does not burn but is exhausted as unburned fuel, which results in deterioration in exhaust emission. In addition, as a larger amount of fuel should be injected for compensation, fuel efficiency in stratified charge combustion is deteriorated. In engine 10 according to the present embodiment, almost all of the fuel spray in a fan shape injected from in-cylinder injector 110 is received in cavity 123C and guided from cavity 123C to the area in the vicinity of spark plug 119. In addition, cavity 123C is formed such that the position of cavity 123C does not overlap with the position of piston pin boss portion 123B.

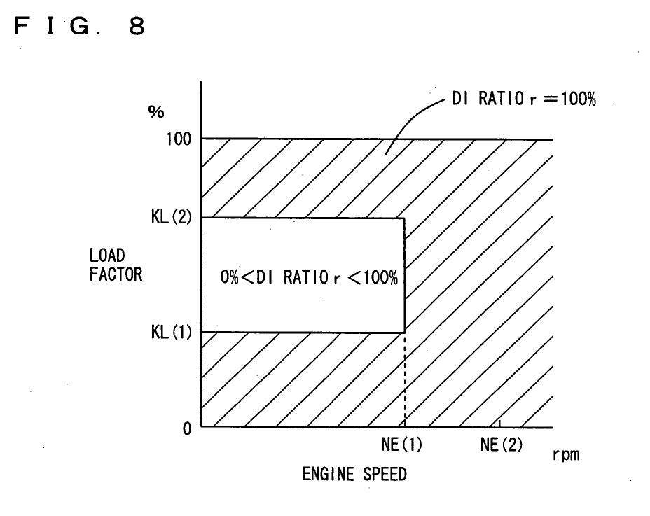

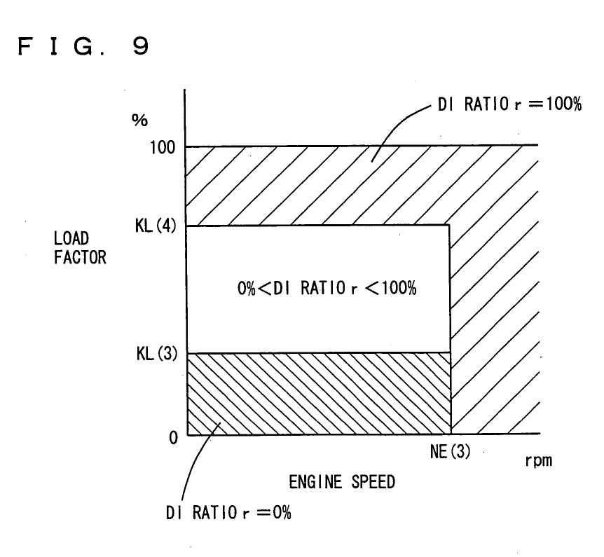

Referring to FIGS. 6 and 7, cavity 123C will be described in detail. FIG. 6 is a side view, while FIG. 7 is a top view.

As shown in FIG. 6, when piston 123 is viewed from the side, the bottom surface of cavity 123C is gently curved such that the fuel spray that is injected from in-cylinder injector 110 and impinges on cavity 123C is directed toward the axial center (spark plug 119) of the cylinder bore. Further, as shown in FIG. 7, when piston 123 is viewed from above, an outermost part of cavity 123C is gently curved such that the inverted V-shaped fuel spray that is injected from in-cylinder injector 110 and impinges on cavity 123C is directed toward the axial center (spark plug 119) of the cylinder bore. In addition, as shown in FIG. 7, the position of cavity 123C does not overlap with the position of piston pin boss portion 123B.

As shown in FIGS. 6 and 7, cavity 123C without a corner portion is formed in a position where the fuel spray formed by the fuel injected from in-cylinder injector 110 impinges on the top surface of piston 123. In addition to not having the corner portion, the shape of cavity 123C is designed such that the fuel spray is directed from cavity 123C toward the area in the vicinity of spark plug 119 when viewed from the side as well as from above. The fuel spray is present in the vicinity of spark plug 119 at the compression top dead center, and is not distributed so distant from the area in the vicinity of spark plug 119 also in the subsequent expansion stroke. In this manner, ignition of the fuel spray can be ensured even if the ignition timing is significantly retarded.

It is not that such cavity 123C is provided only for stratified charge combustion for significantly retarding the ignition timing in order to warm-up three-way catalytic converter 90 at the early stage. When semi-stratified charge combustion is conducted by concentrating a rich air-fuel mixture in the vicinity of spark plug 119 and forming a lean air-fuel mixture around the same as well, an ideal air-fuel mixture can be formed by concentrating the fuel spray in the vicinity of spark plug 119 by means of cavity 123 C shaped as above. In addition, when homogenous combustion is conducted, the local rich state, in which a rich air-fuel mixture is formed in an area other than the area in the vicinity of spark plug 119, can be avoided by means of cavity 123C.

The shape of cavity 123C is as described above. The position of cavity 123C, however, is set so as not to overlap with the position of piston pin boss portion 123B for a reason of structural restriction, as shown in FIG. 7. Though FIG. 7 shows an example in which there is no overlapping of the position of cavity 123C with the position of piston pin boss portion 123B, overlapping at least to such an extent as not causing a structural problem such as stress concentration may be permitted. Therefore, the position of cavity 123C may partially overlap with the position of piston pin boss portion 123B, provided that there is no structural problem caused.

Piston 123 is connected to the connecting rod (not shown) by piston pin 123A, and piston pin boss portion 123B is formed in the lower portion of the piston in order to accommodate piston pin 123A. Here, strong gas force and inertia force of piston 123 are directly applied to piston pin 123A or to piston pin boss portion 123B, and large stress is generated in piston pin boss portion 123B. Therefore, great strength of piston pin boss portion 123B is demanded, and possibility of breakage of piston 123 due to stress concentration should be avoided, in relation to other components formed in piston 123.

In order to avoid stress concentration, in the present embodiment, for example, cavity 123C is provided in the position displaced from the position of piston pin boss portion 123B for securing a thickness. This is because, when the position of piston pin boss portion 123B coincides with the position of cavity 123C, a thickness between cavity 123C and piston pin boss portion 123B becomes smaller and stress concentration may occur.

As described above, according to engine 10 of the present embodiment, the cavity serving as a shallow recess formed by a curved contour in the top surface of the piston is formed at a position displaced from the piston pin boss portion. By means of the cavity, the fuel spray formed by the fuel injected from the in-cylinder injector substantially in a fan shape when it is viewed from the side and substantially in an inverted V-shape when the piston is viewed two-dimensionally can be concentrated in the vicinity of the spark plug, whereby possibility of misfire can be avoided. As a result, an engine including an in-cylinder injector for injecting a fuel into a cylinder, capable of forming a rich air-fuel mixture around the spark plug and mitigating stress in the piston can be provided.

<Engine (1) to Which Present Control Device is Suitably Adapted>

An engine (1) to which the control device of the present embodiment is suitably adapted will now be described.

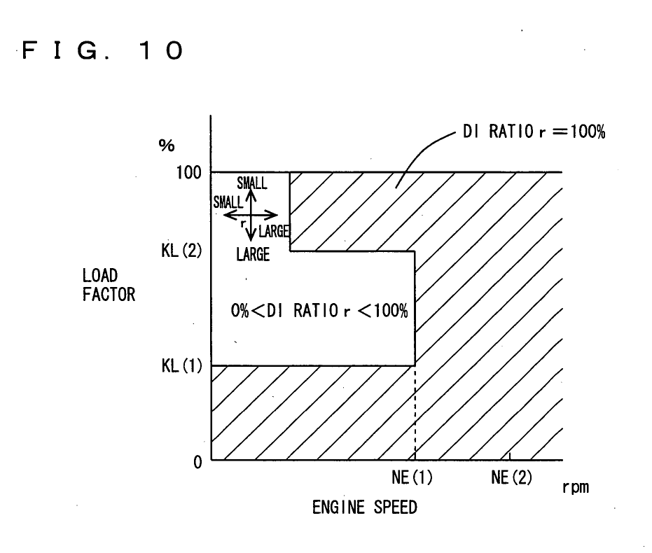

Referring to FIGS. 8 and 9, maps each indicating a fuel injection ratio between in-cylinder injector 110 and intake manifold injector 120 (hereinafter, also referred to as a DI ratio (r)), identified as information associated with an operation state of engine 10, will now be described. The maps are stored in ROM 320 of engine ECU 300. FIG. 8 is the map for a warm state of engine 10, and FIG. 9 is the map for a cold state of engine 10.

In the maps illustrated in FIGS. 8 and 9, with the horizontal axis representing an engine speed of engine 10 and the vertical axis representing a load factor, the fuel injection ratio of in-cylinder injector 110, or the DI ratio r, is expressed in percentage.

As shown in FIGS. 8 and 9, the DI ratio r is set for each operation region that is determined by the engine speed and the load factor of engine 10. “DI RATIO r=100%” represents the region where fuel injection is carried out using only in-cylinder injector 110, and “DI RATIO r=0%” represents the region where fuel injection is carried out using only intake manifold injector 120. “DI RATIO r≠0%”, “DI RATIO r≠100%” and “0%<DI RATIO r<100%” each represent the region where fuel injection is carried out using both in-cylinder injector 110 and intake manifold injector 120. Generally, in-cylinder injector 110 contributes to an increase of output performance, while intake manifold injector 120 contributes to uniformity of the air-fuel mixture. These two kinds of injectors having different characteristics are appropriately selected depending on the engine speed and the load factor of engine 10, so that only homogeneous combustion is conducted in the normal operation state of engine 10 (other than the abnormal operation state such as a catalyst warm-up state during idling).

Further, as shown in FIGS. 8 and 9, the fuel injection ratio between in-cylinder injector 110 and intake manifold injector 120, or the DI ratio r, is defined individually in the map for the warm state and in the map for the cold state of the engine. The maps are configured to indicate different control regions of in-cylinder injector 110 and intake manifold injector 120 as the temperature of engine 10 changes. When the temperature of engine 10 detected is equal to or higher than a predetermined temperature threshold value, the map for the warm state shown in FIG. 8 is selected; otherwise, the map for the cold state shown in FIG. 9 is selected. One or both of in-cylinder injector 110 and intake manifold injector 120 are controlled based on the selected map and according to the engine speed and the load factor of engine 10.

The engine speed and the load factor of engine 10 set in FIGS. 8 and 9 will now be described. In FIG. 8, NE(1) is set to 2500 rpm to 2700 rpm, KL(1) is set to 30% to 50%, and KL(2) is set to 60% to 90%. In FIG. 9, NE(3) is set to 2900 rpm to 3100 rpm. That is, NE(1)<NE(3). NE(2) in FIG. 8 as well as KL(3) and KL(4) in FIG. 9 are also set as appropriate.

When comparing FIG. 8 and FIG. 9, NE(3) of the map for the cold state shown in FIG. 9 is greater than NE(1) of the map for the warm state shown in FIG. 8. This shows that, as the temperature of engine 10 is lower, the control region of intake manifold injector 120 is expanded to include the region of higher engine speed. That is, in the case where engine 10 is cold, deposits are unlikely to accumulate in the injection hole of in-cylinder injector 110 (even if the fuel is not injected from in-cylinder injector 110). Thus, the region where the fuel injection is to be carried out using intake manifold injector 120 can be expanded, to thereby improve homogeneity.

When comparing FIG. 8 and FIG. 9, “DI RATIO r=100%” in the region where the engine speed of engine 10 is NE(l) or higher in the map for the warm state, and in the region where the engine speed is NE(3) or higher in the map for the cold state. In terms of load factor, “DI RATIO r=100%” in the region where the load factor is KL(2) or greater in the map for the warm state, and in the region where the load factor is KL(4) or greater in the map for the cold state. This means that in-cylinder injector 110 solely is used in the region of a predetermined high engine speed, and in the region of a predetermined high engine load. That is, in the high speed region or the high load region, even if fuel injection is carried out using only in-cylinder injector 110, the engine speed and the load of engine 10 are high, ensuring a sufficient intake air quantity, so that it is readily possible to obtain a homogeneous air-fuel mixture even using only in-cylinder injector 110. In this manner, the fuel injected from in-cylinder injector 110 is atomized within the combustion chamber involving latent heat of vaporization (or, absorbing heat from the combustion chamber). Thus, the temperature of the air-fuel mixture is decreased at the compression end, whereby antiknock performance is improved. Further, since the temperature within the combustion chamber is decreased, intake efficiency improves, leading to high power output.

In the map for the warm state in FIG. 8, fuel injection is also carried out using only in-cylinder injector 110 when the load factor is KL(1) or less. This shows that in-cylinder injector 110 alone is used in a predetermined low load region when the temperature of engine 10 is high. When engine 10 is in the warm state, deposits are likely to accumulate in the injection hole of in-cylinder injector 110. However, when fuel injection is carried out using in-cylinder injector 100, the temperature of the injection hole can be lowered, whereby accumulation of deposits is prevented. Further, clogging of in-cylinder injector 110 may be prevented while ensuring the minimum fuel injection quantity thereof. Thus, in-cylinder injector 110 alone is used in the relevant region.

When comparing FIG. 8 and FIG. 9, there is a region of “DI RATIO r=0%” only in the map for the cold state in FIG. 9. This shows that fuel injection is carried out using only intake manifold injector 120 in a predetermined low load region (KL(3) or less) when the temperature of engine 10 is low. When engine 10 is cold and low in load and the intake air quantity is small, atomization of the fuel is unlikely to occur. In such a region, it is difficult to ensure favorable combustion with the fuel injection from in-cylinder injector 110. Further, particularly in the low-load and low-speed region, high output using in-cylinder injector 110 is unnecessary. Accordingly, fuel injection is carried out using only intake manifold injector 120, rather than in-cylinder injector 110, in the relevant region.

Further, in an operation other than the normal operation, or in the catalyst warm-up state during idling of engine 10 (abnormal operation state), in-cylinder injector 110 is controlled to carry out stratified charge combustion. By causing the stratified charge combustion only during the catalyst warm-up operation, warming up of the catalyst is promoted, and exhaust emission is thus improved.

<Engine (2) to Which Present Control Device is Suitably Adapted>

Hereinafter, an engine (2) to which the control device of the present embodiment is suitably adapted will be described. In the following description of the engine (2), the configurations similar to those of the engine (1) will not be repeated.

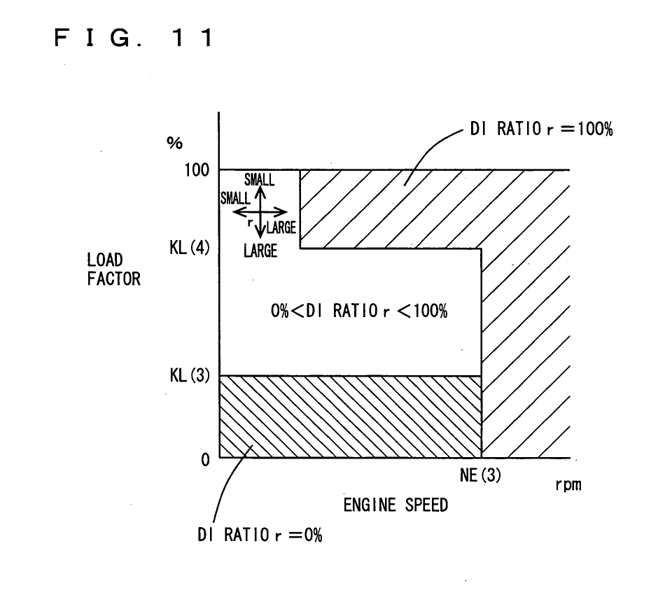

Referring to FIGS. 10 and 11, maps each indicating the fuel injection ratio between in-cylinder injector 110 and intake manifold injector 120, identified as information associated with the operation state of engine 10, will be described. The maps are stored in ROM 320 of engine ECU 300. FIG. 10 is the map for the warm state of engine 10, and FIG. 11 is the map for the cold state of engine 10.

FIGS. 10 and 11 differ from FIGS. 8 and 9 in the following points. “DI RATIO r=100%” holds in the region where the engine speed of engine 10 is equal to or higher than NE(1) in the map for the warm state, and in the region where engine 10 speed is NE(3) or higher in the map for the cold state. Further, except for the low-speed region, “DI RATIO r=100%” holds in the region where the load factor is KL(2) or greater in the map for the warm state, and in the region where the load factor is KL(4) or greater in the map for the cold state. This means that fuel injection is carried out using only in-cylinder injector 110 in the region where the engine speed is at a predetermined high level, and that fuel injection is often carried out using only in-cylinder injector 110 in the region where the engine load is at a predetermined high level. However, in the low-speed and high-load region, mixing of an air-fuel mixture formed by the fuel injected from in-cylinder injector 110 is poor, and such inhomogeneous air-fuel mixture within the combustion chamber may lead to unstable combustion. Thus, the fuel injection ratio of in-cylinder injector 110 is increased as the engine speed increases where such a problem is unlikely to occur, whereas the fuel injection ratio of in-cylinder injector 110 is decreased as the engine load increases where such a problem is likely to occur. These changes in the DI ratio r are shown by crisscross arrows in FIGS. 10 and 11. In this manner, variation in output torque of the engine attributable to the unstable combustion can be suppressed. It is noted that these measures are approximately equivalent to the measures to decrease the fuel injection ratio of in-cylinder injector 110 as the state of engine 10 moves toward the predetermined low speed region, or to increase the fuel injection ratio of in-cylinder injector 110 as engine 10 state moves toward the predetermined low load region. Further, except for the relevant region (indicated by the crisscross arrows in FIGS. 10 and 11), in the region where fuel injection is carried out using only in-cylinder injector 110 (on the high speed side and on the low load side), a homogeneous air-fuel mixture is readily obtained even when the fuel injection is carried out using only in-cylinder injector 110. In this case, the fuel injected from in-cylinder injector 110 is atomized within the combustion chamber involving latent heat of vaporization (by absorbing heat from the combustion chamber). Accordingly, the temperature of the air-fuel mixture is decreased at the compression end, and thus, the antiknock performance improves. Further, with the temperature of the combustion chamber decreased, intake efficiency improves, leading to high power output.

In engine 10 explained in conjunction with FIGS. 8-11, homogeneous combustion is achieved by setting the fuel injection timing of in-cylinder injector 110 in the intake stroke, while stratified charge combustion is realized by setting it in the compression stroke. That is, when the fuel injection timing of in-cylinder injector 110 is set in the compression stroke, a rich air-fuel mixture can be located locally around the spark plug, so that a lean air-fuel mixture in the combustion chamber as a whole is ignited to realize the stratified charge combustion. Even if the fuel injection timing of in-cylinder injector 110 is set in the intake stroke, stratified charge combustion can be realized if it is possible to provide a rich air-fuel mixture locally around the spark plug.

As used herein, the stratified charge combustion includes both the stratified charge combustion and semi-stratified charge combustion. In the semi-stratified charge combustion, intake manifold injector 120 injects fuel in the intake stroke to generate a lean and homogeneous air-fuel mixture in the whole combustion chamber, and then in-cylinder injector 110 injects fuel in the compression stroke to generate a rich air-fuel mixture around the spark plug, so as to improve the combustion state. Such semi-stratified charge combustion is preferable in the catalyst warm-up operation for the following reasons. In the catalyst warm-up operation, it is necessary to considerably retard the ignition timing and maintain a favorable combustion state (idle state) so as to cause a high-temperature combustion gas to reach the catalyst. Further, a certain quantity of fuel needs to be supplied. If the stratified charge combustion is employed to satisfy these requirements, the quantity of the fuel will be insufficient. If the homogeneous combustion is employed, the retarded amount for the purpose of maintaining favorable combustion is small compared to the case of stratified charge combustion. For these reasons, the above-described semi-stratified charge combustion is preferably employed in the catalyst warm-up operation, although either of stratified charge combustion and semi-stratified charge combustion may be employed.

Further, in the engine explained in conjunction with FIGS. 8-11, the fuel injection timing of in-cylinder injector 110 is set in the intake stroke in a basic region corresponding to the almost entire region (here, the basic region refers to the region other than the region where semi-stratified charge combustion is carried out with fuel injection from intake manifold injector 120 in the intake stroke and fuel injection from in-cylinder injector 110 in the compression stroke, which is carried out only in the catalyst warm-up state). The fuel injection timing of in-cylinder injector 110, however, may be set temporarily in the compression stroke for the purpose of stabilizing combustion, for the following reasons.

When the fuel injection timing of in-cylinder injector 110 is set in the compression stroke, the air-fuel mixture is cooled by the injected fuel while the temperature in the cylinder is relatively high. This improves the cooling effect and, hence, the antiknock performance. Further, when the fuel injection timing of in-cylinder injector 110 is set in the compression stroke, the time from the fuel injection to the ignition is short, which ensures strong penetration of the injected fuel, so that the combustion rate increases. The improvement in antiknock performance and the increase in combustion rate can prevent variation in combustion, and thus, combustion stability is improved.

Regardless of the temperature of engine 10 (that is, whether engine 10 is in the warm state or in the cold state), the warm state map shown in FIG. 8 or 10 may be used during idle-off state (when an idle switch is off, or when the accelerator pedal is pressed).

Although the present invention has been described and illustrated in detail, it is clearly understood that the same is by way of illustration and exaimple only and is not to be taken by way of limitation, the spirit and scope of the present invention being limited only by the terms of the appended claims.

1. An internal combustion engine including a fuel injection mechanism for injecting a fuel into a cylinder, comprising:
an intake manifold formed on one side of a cylinder head when a cylinder, in which an axial center of a cylinder bore is aligned with a vertical line, is viewed from a side;
an exhaust manifold formed on a side opposite to said intake manifold; and
a piston making up-down movement through said cylinder bore,
wherein said fuel injection mechanism is capable of injecting a fuel in an obliquely downward direction from an end side on said one side of said cylinder head into said cylinder bore,
said piston is provided with a cavity in a top surface such that a spray formed by the fuel injected from said fuel injection mechanism comes in contact with the top surface of the piston in an outermost portion of the cavity, and
a position of said cavitv does not overlap a position of a piston pin boss when viewed from above.

2. (canceled)

3. The internal combustion engine according to claim 1, further comprising a spark plug of which discharge portion is exposed in said cylinder bore substantially on the axial center of said cylinder bore.

4. The internal combustion engine according to claim 1, further comprising a spark plug of which discharge portion is exposed in said cylinder bore.

5. The internal combustion engine according to claim 4, wherein
when said cylinder is viewed two-dimensionally, the fuel injected from said fuel injection mechanism is in an inverted V-shape with said discharge portion lying between two prongs.

6. The internal combustion engine according to claim 4, wherein
when said cylinder is viewed two-dimensionally, the fuel injected from said fuel injection mechanism is in an inverted V-shape with said discharge portion lying between two prongs, and when said cylinder is viewed from a side, the fuel injected from said fuel injection mechanism is in a fan shape.

7. The internal combustion engine according to claim 4, wherein
said cavity is shaped such that the spray that impinges on said outermost portion is directed toward said discharge portion when said cylinder is viewed two-dimensionally.

8. The internal combustion engine according to claim 4, wherein
said cavity is shaped such that the spray that impinges on a bottom portion of said cavity is directed toward said discharge portion when said cylinder is viewed from a side.

9. The internal combustion engine according to claim 1, further comprising a fuel injection mechanism injecting a fuel into an intake manifold.

10. The internal combustion engine according to claim 9, wherein
said fuel injection mechanism for injecting the fuel into said cylinder is an in-cylinder injector, and
said fuel injection mechanism for injecting the fuel into said intake manifold is an intake manifold injector.

11. The internal combustion engine according to claim 2, further comprising a fuel injection mechanism injecting a fuel into an intake manifold.

12. The internal combustion engine according to claim 3, further comprising a fuel injection mechanism injecting a fuel into an intake manifold.

13. The internal combustion engine according to claim 4, further comprising a fuel injection mechanism injecting a fuel into an intake manifold.

14. The internal combustion engine according to claim 5, further comprising a fuel injection mechanism injecting a fuel into an intake manifold.

15. The internal combustion engine according to claim 6, further comprising a fuel injection mechanism injecting a fuel into an intake manifold.

16. The internal combustion engine according to claim 7, further comprising a fuel injection mechanism injecting a fuel into an intake manifold.

17. The internal combustion engine according to claim 8, further comprising a fuel injection mechanism injecting a fuel into an intake manifold.
